(19) United States
(12) Patent Application Publication
(10) Pub. No.: US 2005/0035220 A1
(43) Pub. Date: Feb. 17, 2005

(54) Multi-component fluid nozzle assembly with detachable nozzle spray tip

(76) Inventor: Daniel P. Brown, Palos Park, IL (US)

Correspondence Address: QUARLES & BRADY LLP, 411 E. WISCONSIN AVENUE, SUITE 2040, MILWAUKEE, WI, 53202-4497, US

(21) Appl. No.: 10/638,613

(22) Filed: Aug. 11, 2003

(51) Int. Cl. B05B 7/06

(52) U.S. Cl. 239/432; 239/525; 239/600; 239/413; 239/414; 239/427

(57) ABSTRACT

A nozzle assembly having a mixing nozzle that dispenses foam in a particular pattern. A spray tip detachably fixable to the mixing nozzle that produces a foam spray pattern that is different from the spray pattern produced by the mixing nozzle alone

### CROSS REFERENCES TO RELATED APPLICATIONS

Not Applicable

### STATEMENT REGARDING FEDERALLY SPONSORED RESEARCH

Not Applicable

### TECHNICAL FIELD

This invention relates to a multi-component mixing nozzle with removable low cost spray pattern control tips to vary the spray pattern of a plural component mixed material. Two or more fluid components are mixed and processed into a settable plastic through a nozzle and depending on the application are sprayed our poured out of the nozzle. The new designed tip of this invention allows the end user to choose to use the pattern-modifying tip on the mixing nozzle or simply use a nozzle without the modifying tip, depending on the application.

### DESCRIPTION OF THE BACKGROUND ART

Manually operable guns are known for dispensing a settable urethane foam. Separate fluid components are fed individually to the gun, passed separately through control valves, and brought into contact with each other upon reaching a mixing chamber of a nozzle from which the mixed components are discharged as foam. Examples of such guns are found in U.S. Pat. Nos. 4,311,254 and 4,399,930 issued to Gary Harding and in U.S. Pat. No. 4,762,253 issued to Steven Palmert.

The two fluid components are commonly referred to as the “A resin” and the “B resin”. They usually consist of polymeric isocyanate and polyol amine, respectively. The components are supplied separately in two pressurized containers that are attached by hoses to inlets to the guns. When the two fluid components or resins are mixed, the mixture quickly sets up to form a rigid foam product which is substantially insoluble and extremely difficult to remove from surfaces with which it comes in contact. As a result, the nozzles for the guns in which the two components are first mixed are typically designed to be replaceable and disposable so as to avoid the necessity for cleaning the nozzles.

There are a variety of mixing nozzles available which can produce different dedicated spray patterns depending on the nozzle design. The nature of what nozzle to use depends on the end user's application. Typically, a supplier includes a number of standard pattern dedicated nozzles with a kit containing the dispenser and foam components. If the user desires a spray pattern different from the standard nozzle included with the system, they must be purchased separately. The spray tip of this invention allow for the supplier to make available to the end users a variety of spray pattern control tips that are inexpensive to produce, easy to stock, inexpensive to distribute and can adapt to the existing mixing nozzles supplied with the system. An inventory of spray nozzles could be kept on site in case they are needed. However, the nozzles are expensive, and the standard nozzles are then wasted.

A detachable nozzle tip for use with a single component foam dispensing gun is disclosed in U.S. Pat. No. 5,645,199. Single component guns, however, do not include mixing chambers to mix two or more foam components since by definition, single component foam dispensing guns only have one component, and thus do not require mixing. Moreover, the nozzle tip disclosed in U.S. Pat. No. 5,645,199 is not a spray tip that produces a spray pattern. The nozzle tip disclosed in the patent merely extends the length of the nozzle to dispense foam caulk into difficult to reach cracks and crevices.

### SUMMARY OF THE INVENTION

The present invention provides a multi-component fluid nozzle assembly including a mixing nozzle and kit including a multi-component fluid mixing nozzle. The assembly and kit include a detachably fixable spray tip that produces a foam spray pattern that is different from the spray pattern produced by the mixing nozzle alone.

A general objective of the present invention is to provide a multi-component fluid nozzle assembly and a foam dispensing kit which does not require changing a mixing nozzle to change a first spray pattern defined by foam exhausting from the mixing nozzle outlet. This objective is accomplished by provide a spray tip that is detachably fixable to the standard mixing nozzle outlet and foam exhausting from the spray tip outlet defines a second spray pattern, wherein the second spray pattern is different from the first spray pattern.

The foregoing and other objectives and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF SUMMARY OF THE DRAWINGS

FIG. 1 is a view in elevation of a foam dispensing gun in accordance with the present invention with a detachable spray tip removed;

FIG. 2 is a view in horizontal section taken in the plane of the line 2-2 of FIG. 1;

FIG. 3 is a detailed partial view in vertical section taken in the plane of the line 3-3 in FIG. 2 showing the valve members in an open position;

FIG. 4 is a detailed view of the spray tip detachably fixed to the nozzle of FIG. 2;

FIG. 5 is a cross sectional view of FIG. 4;

FIG. 6 is a rear view of the spray tip of FIG. 3;

FIG. 7 is a sectional view along line 7-7 of FIG. 6;

FIG. 8 is a sectional view along line 8-8 of FIG. 6

FIG. 9a is a perspective view of the spray tip of FIG. 4;

FIG. 9b is a front view of the spray tip of FIG. 9a;

FIG. 9c is a sectional view along line 9c-9c of FIG. 9b;

FIG. 9d is a top view of the spray tip of FIG. 9a;

FIG. 10a is a perspective view of an alternative spray tip;

FIG. 10b is a front view of the spray tip of FIG. 10a;

FIG. 10c is a sectional view along line 10c-10c of FIG. 10b;

FIG. 10d is a top view of the spray tip of FIG. 10a;

FIG. 11a is a perspective view of an alternative spray tip;

FIG. 11b is a front view of the spray tip of FIG. 11a;

FIG. 11c is a sectional view along line 11c-11c of FIG. 11b;

FIG. 11d is a top view of the spray tip of FIG. 11a;

FIG. 12a is a perspective view of an alternative spray tip;

FIG. 12b is a front view of the spray tip of FIG. 12a;

FIG. 12c is a sectional view along line 12c-12c of FIG. 12b with a hose attached; and

FIG. 12d is a top view of the spray tip of FIG. 12a

### DETAILED DESCRIPTION OF THE PREFERRED EMBODIMENTS

The foam dispensing gun disclosed herein is substantially identical to the foam dispensing gun disclosed in U.S. Pat. No. 5,462,204 with the exception that it includes, as described below, a detachable spray tip for producing a spray pattern different than the spray pattern produced by a nozzle forming part of the gun. U.S. Pat. No. 5,462,204 is assigned to the assignee of the present invention, and is fully incorporated herein by reference. Although the foam dispensing gun having a modified standard mixing nozzle disclosed herein is preferred, any multi-component mixing nozzle can be modified to include a detachable spray tip without departing from the scope of the invention.

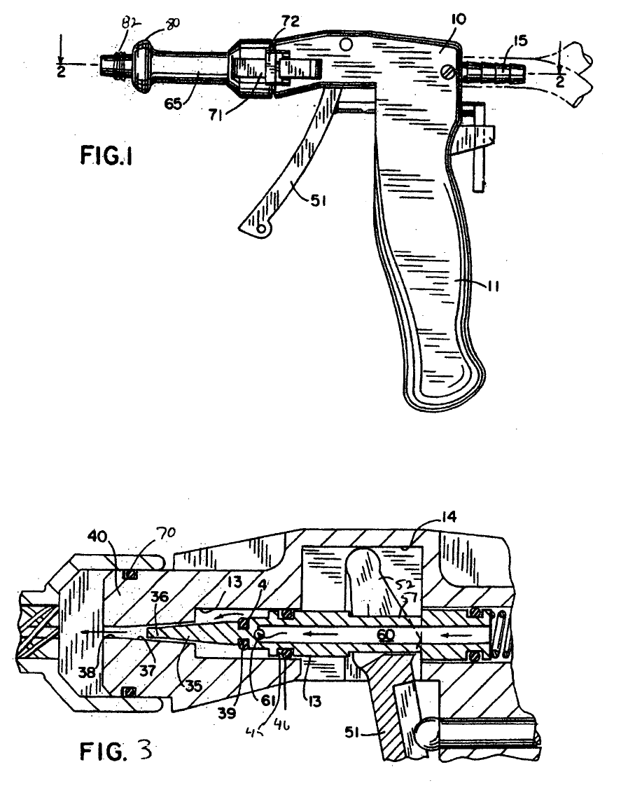

Referring to FIGS. 1-3, in general, the foam dispensing gun includes a body 10 with a handle 11 that may be formed integral with the body 10. The body 10 and handle 11 may be molded from a synthetic resin material. The body 10 is formed with a pair of longitudinal, parallel passageways 12 and 13. The passageways 12 and 13 are divided into forward and rearward portions by an intermediate chamber 14. The rearward portions of the passageways 12 and 13 mount brass connectors 15 that have a ribbed end for attachment to hoses connected to pressurized containers for fluid components that are used to form the foam.

The connectors 15 are hollow and define passageway inlets leading from the tanks of components. The bushings 22 are also hollow and mount duck-bill valves 25 in their center. The duck-bill valves 25 are formed of a rubber or other elastomeric material and function as one-way valves to permit fluid under pressure to enter a passageway 12 or 13.

Each bushing 22 is disposed against a bellville spring 26 which bears against an end of the respective connector 15 thereby urging the bushing 22 inwardly in the passageway 12 or 13 until it abuts against a shoulder 27. A coiled spring 30 is disposed in each of the passageways 12 and 13. The spring 30 bears at one end against an end of a respective bushing 22. The other ends of the springs 30 bear against the ends of brass needle valve members 31 also disposed in the passageways 12 and 13.

The needle valve members 31 span the chamber 14 and are received in both the forward and rearward portions of the passageways 12 and 13. The needle valve members 31 have a rear portion provided with a radial recess 32 that mounts an O-ring 33 to seal with the rearward portion of the passageway 12 or 13. The forward portion of each valve member 31 is formed as a conical needle valve portion 35 terminating in a circular cylindrical tip 36. The conical needle valve portion 35 and tip 36 mate with a conical valve seat 37 having a circular cylindrical extension 38 and formed in the body 10 at the front terminus of the passageways 12 and 13.

The valve seats 37 define passageway outlets, and open directly through the front face of a nose 40 on the body 10. The valve members 31 have an annular recess 39 behind the conical needle valve portion 35. The recess 39 mounts an O-ring 41 that seals the junction of the needle valve portion 35 and the conical valve seat 37 when the valve is closed, as shown in FIG. 4. The valve members 31 have an additional annular recess 45 that mounts an O-ring 46 that seals with the forward portions of the passageways 12 and 13.

The chamber 14 mounts a yoke 50 formed at the top of a trigger lever 51. The yoke 50 has a pair of arms 52 terminating in lateral bosses 53 that are received for pivotal movement in holes 54 in the two sides of the body 10, as shown in FIG. 3. The yoke 50 also includes a central rib 55 which, with the arms 52, defines two spaced cradles 56 that receive necked down portions 57 intermediate the ends of the valve members 31. The springs 30 normally urge the valve members 31 forwardly to close the needle valves 35 against the valve seats 37. The trigger lever 51 can be rotated to withdraw the valve members 31 against the urgings of the springs 30 to open the valves.

Each valve member 31 has a central internal passage 60 that terminates in a transverse port 61 that extends to the surface of the valve member at a point between the O-rings 40 and 46. As shown in FIG. 5, when the trigger lever 51 is squeezed to open the valves, fluid from the pressurized containers can pass through the central passages 60 in the valve members 31, out the ports 61, through the valve seats 37, and out of the front nose 40 of the body 10. The O-rings 46 prevent fluid from moving rearwardly along the passageways 12 or 13. As the valves are closed, the conical needle valve portions will extrude materials forwardly out of the valve seats. The seating of the needle valve in the valve seat combined with the O-rings 40 will seal off the interior of the passageways and prevent air from reaching the fluid resins in such passageways.

A disposable mixing nozzle 65 is mounted on the front of the gun. The nozzle 65 has a hollow interior that defines a mixing chamber 66 and interposed between an inlet chamber and an outlet 67. A helical static mixer 68 of known construction is mounted in the mixing chamber 66. The rear end of the nozzle upstream of the mixing chamber 66 has an enlarged circular cylindrical portion 69 which surrounds the nose 40 of the body 10 and is sealed thereto by an O-ring 70. The cylindrical portion 69 also defines the open inlet chamber. An annular ring 80 formed around the nozzle 65 proximal the outlet 67 provides grasping surfaces for securely grasping the nozzle 65 when attaching and detaching the nozzle 65 from the gun body 10. External threads 82 are formed on the nozzle 65 forward of the annular ring 80 for threadably engaging a detachable spray tip 84, such as shown in FIGS. 4-8.

A pair of resilient arms 71 extend along either side of the nozzle rearwardly from the enlarged cylindrical portion 69. The resilient arms 71 are adapted to engage ears 72 that extend from opposite sides of the body 10 adjacent the nose 40. The resilient arms 71 have a curved portion 73 adjacent their ends which terminates in a notch 74 that mates with an ear 72. The nozzle can be quickly attached to the body 10 by sliding the resilient arms 71 beneath the ears 72. The curved portions 73 will cam the arms 71 so that the arms will slide easily past the ears 72 until the notches 74 engages with the ears 72. The nozzles 65 can be easily removed by manually depressing the curved ends 73 of the arms 71 to release the notches 74 from the ears 72 and allow the arms 71 to slide past the ears 72. Although detachably fixing the nozzle to the body is preferred, as described above, the nozzle can form an integral and/or permanent part of the body, or be detachably fixed to the body using other methods, such as by using a threaded engagement, snap fit, friction fit, fasteners, and the like, without departing from the scope of the invention.

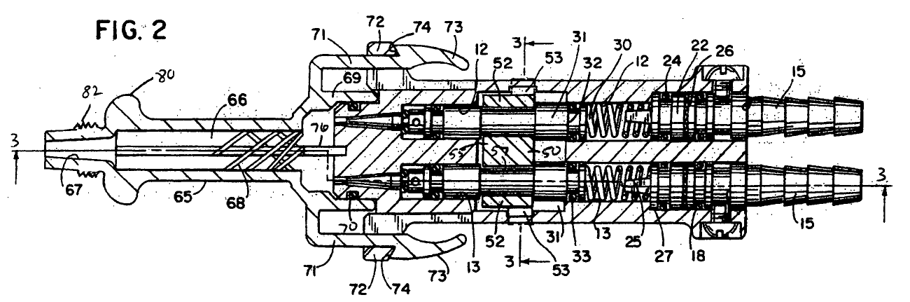

The static mixer 68 includes a wall portion 76 which is located in the open inlet chamber defined by the enlarged cylindrical end 69 of the nozzle. As shown in FIG. 2, the wall portion 76 divides the inlet chamber and is positioned between the valve seats 37 so that complete mixing of the two fluid components does not occur immediately at the nose 40. If the nozzle 65 should become clogged with foam and not be replaced, the subsequent opening of the valves could result in the fluid of higher pressure being forced from the mixing chamber through the valve seat for the other component in the reverse direction. The duckbill valves 25 prevent such cross-contamination which would result in set-up of the components within the gun if allowed to occur.

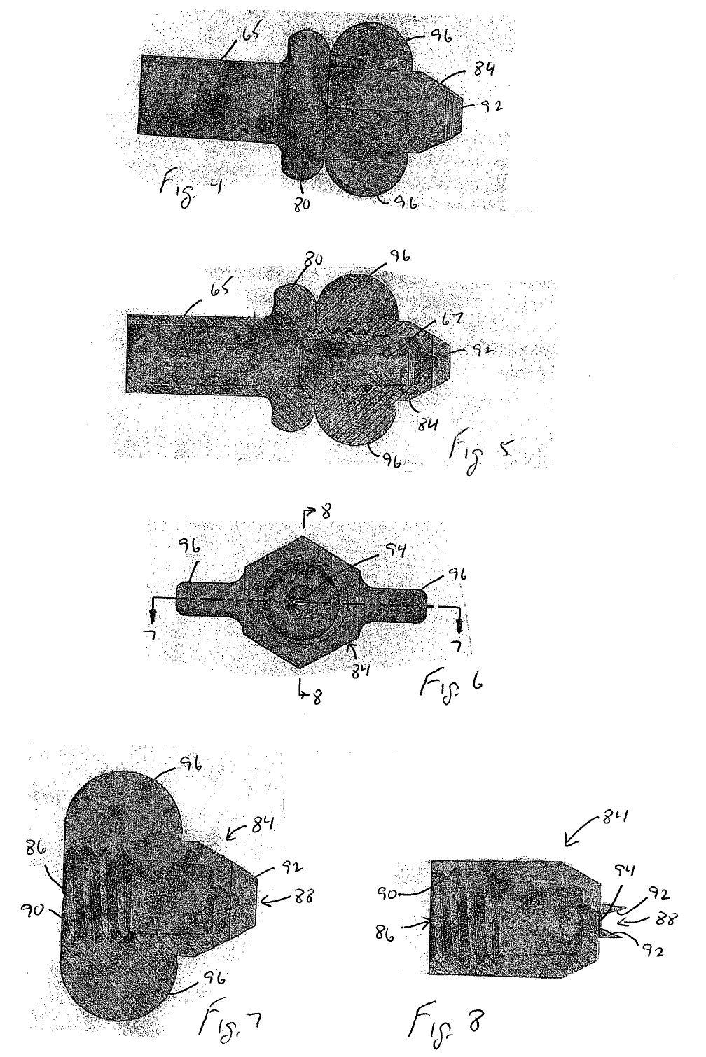

Referring now to FIGS. 4-9d, the nozzle outlet 67 exhausts into the detachable spray tip 84 fixed to the nozzle 65. The spray tip 84 includes a hollow interior having a spray tip inlet 86 in fluid communication with a spray tip outlet 88. Preferably, the spray tip inlet 86 includes internal threads 90 that threadably engage the external threads 82 formed on the nozzle 65 to detachably fix the spray tip 84 to the nozzle 65. Although threadably engaging the spray tip with the nozzle is preferred, other means for detachably fixing the spray tip to the nozzle outlet end, such as a twist lock engagement, friction fit, snap fit, and the like, can be used without departing from the scope of the invention. Moreover, fasteners, such as set screws, hose clamps, bands, and the like, can be used to more securely fix the spray tip to the nozzle outlet end.

The spray tip outlet 88 can be any shape to produce the desired spray pattern. Preferably, the spray pattern produced by the spray tip outlet 88 is different from the spray pattern produced by the nozzle outlet 67 without a spray tip 84 affixed thereto. In the embodiment disclosed in FIG. 6, the spray tip outlet is a small generally rectangular aperture 94 in fluid communication with the hollow interior and exhausting between a pair of diverging walls 92. Preferably, the walls 92 diverge at an angle of no more than 28° to control the foam spray exiting from the spray tip outlet 88. Other exhaust shapes can include a plurality of apertures in fluid communication with the inlet, an elongated slit, a tubular opening having any desired diameter, a conical aperture having an increasing diameter, and the like, without departing from the scope of the invention.

Opposing wings 96 extending radially from the spray tip 84 provide engagement surfaces for rotating the spray tip 84 to threadably engage the internal threads 90 with the external threads 82. Of course, other means can be provided for securely grasping the spray tip to detachably fix the spray tip to the nozzle end, such as a single wing, a knurled exterior surface, a geometric external cross section for engaging a wrench, and the like, without departing from the scope of the invention.

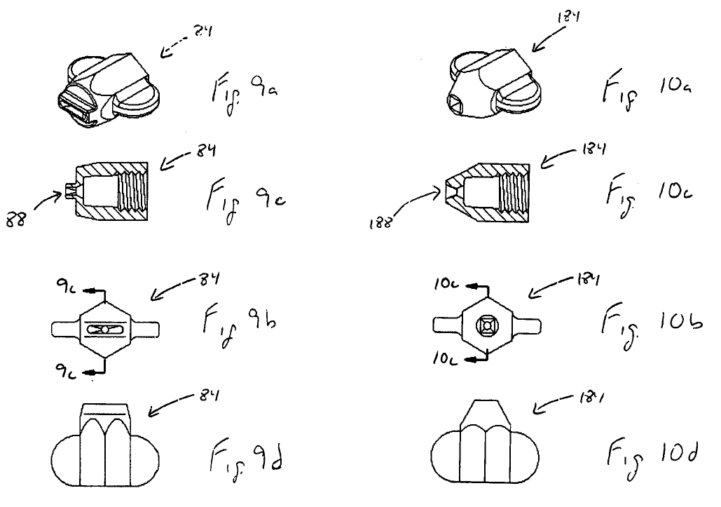

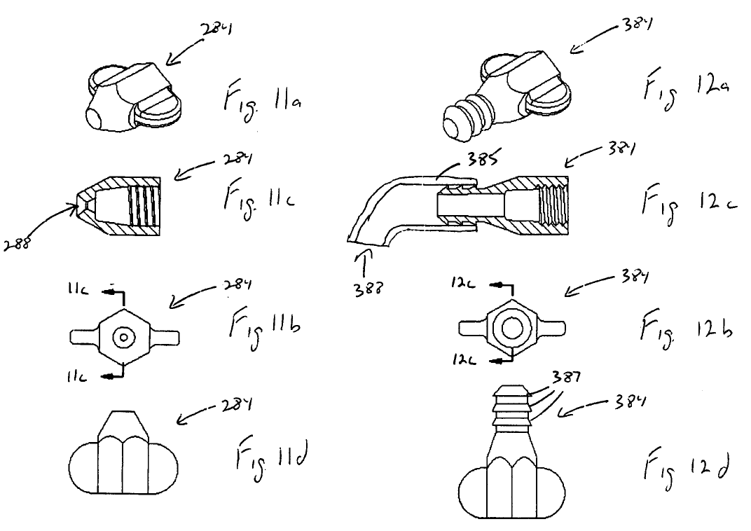

In other embodiments of the present invention, spray tips 184, 284 shown in FIGS. 10a-11d have spray tip outlets 188, 288 that are different from the spray tip outlet 88 disclosed in FIGS. 4-9d above. As in the first embodiment disclosed herein, the spray tip outlets 188, 288 disclosed in FIGS. 10a-11d produce a spray pattern that is different from the spray pattern produced by the nozzle outlet 67 without a spray tip.

In yet another embodiment of the present invention shown in FIG. 12a-12d, a replaceable spray tip 384 includes a flexible hose 385 for modifying the foam spray pattern. The spray tip 384 is detachably fixed to the nozzle outlet 67 and includes external barbs 387 for attaching the hose 385 thereto. The spray tip 384 including the flexible hose 385 affixed thereto has an outlet 388 that can produce spray patterns different from the spray pattern produced by the nozzle outlet 67 without a spray tip affixed thereto. Advantageously, a plurality of spray tips 384, each having different sized barbs 387 can be provided to accommodate different diameter flexible hoses without replacing the nozzle.

The detachable spray tip disclosed herein provides a user with increased flexibility. The user can spray foam through the nozzle without the spray tip to produce a foam spray having a known spray pattern, or the user can affix a spray tip to the nozzle to produce a different foam spray pattern without replacing or purchasing a different nozzle. This saves time and money by reducing waste and increasing inefficiency. Moreover, the spray tips can be provided at a larger variety and lower cost than an entire nozzle which allows a user to maintain an inventory of spray tips for use.

While there has been shown and described what is at present considered the preferred embodiment of the invention, it will be obvious to those skilled in the art that various changes and modifications can be made therein without departing from the scope of the invention defined by the appended claims.

1. A multi-component fluid nozzle assembly comprising:
a mixing nozzle having a mixing chamber in fluid communication with a nozzle inlet and a nozzle outlet, said nozzle inlet being adapted for receiving at least two fluid components therethrough, wherein said at least two fluid components are mixed in said mixing chamber to form a foam which exhausts from said nozzle outlet, said foam exhausting from said nozzle outlet defines a first spray pattern; and
a spray tip detachably fixed to said nozzle outlet, and having a spray tip inlet and a spray tip outlet, said spray tip inlet being in fluid communication with said nozzle outlet, and said spray tip outlet being in fluid communication with said spray tip inlet to exhaust foam therethrough, and foam exhausting from said spray tip outlet defines a second spray pattern, wherein said second spray pattern is different from said first spray pattern.

2. The nozzle assembly as in claim 1, in which said nozzle outlet includes external threads, and said spray tip inlet includes internal threads that threadably engage the external threads to detachably fix said spray tip to said nozzle outlet.

3. The nozzle assembly as in claim 1, in which at least one wing extends radially from said spray tip to provide an engagement surface for engagement by a user.

4. The nozzle assembly as in claim 1, in which said spray tip outlet is selected from a group consisting of a rectangular aperture, a slit, a conical aperture.

5. The nozzle assembly as in claim 1, in which a flexible hose is affixed to said spray tip and is in fluid communication with said spray trip outlet to exhaust foam therethrough defining said second spray pattern.

6. The nozzle assembly as in claim 1, in which said nozzle is detachably fixed to said body.

7. A foam dispensing kit comprising:
a multi-component fluid mixing nozzle including a mixing chamber and a nozzle outlet, wherein foam exhausting from said nozzle outlet defines a first spray pattern; and
at least one spray tip detachably fixable to said nozzle outlet, and having a spray tip inlet and a spray tip outlet, said spray tip outlet being in fluid communication with said spray tip inlet to exhaust foam therethrough when said spray tip is detachably fixed to said nozzle outlet, and foam exhausting through said spray tip outlet defines a second spray pattern, wherein said second spray pattern is different from said first spray pattern.

8. The foam dispensing kit as in claim 7, in which said nozzle outlet includes external threads, and said spray tip inlet includes internal threads that threadably engage the external threads to detachably fix said spray tip to said nozzle outlet.

9. The foam dispensing kit as in claim 7, in which at least one wing extends radially from said spray tip to provide an engagement surface for engagement by a user.

10. The foam dispensing kit as in claim 7, in which said spray tip outlet is selected from a group consisting of a rectangular aperture, a slit, a conical aperture.

11. The foam dispensing kit as in claim 7, in which a flexible hose is affixed to said spray tip and is in fluid communication with said spray trip outlet to exhaust foam therethrough defining said second spray pattern.

12. The foam dispensing kit as in claim 7, in which said nozzle is detachably fixed to a multi-component fluid dispensing gun.
